(19) United States
(12) Patent Application Publication
(10) Pub. No.: US 2008/0016946 A1
(43) Pub. Date: Jan. 24, 2008

(54) Gas sensor packaging for elevated temperature and harsh environment and related methods

(75) Inventors: Palani Thanigachalam, Bangalore (IN); Ramsesh Anilkumar, Bangalore (IN)

Correspondence Address: Attorney, Intellectual Property;Honeywell International Inc., 101 Columbia Rd., P.O. Box 2245, Morristown, NJ, 07962, US

(73) Assignee: Honeywell International Inc.

(21) Appl. No.: 11/488,290

(22) Filed: Jul. 18, 2006

(51) Int. Cl. G01N 7/00

(52) U.S. Cl. 73/31.05

(57) ABSTRACT

A sensor assembly for measuring a gas parameter includes a sensing element cover. A bottom wall and the sidewall of the cover have openings configured such that, when the cover is attached to the the sensor so as to surround the sensing element and gas is flowing into the cover interior via the sidewall opening, the gas flow in the cover interior is drawn in a downward motion and concentrated in the vicinity of the sensing element. The openings can be configured to promote rotary or swirling movement of the gas flow in the cover interior. Also, the cover can have an outer cover surrounding an inner cover and the outer cover can have openings only on the cover upstream side to concentrate flow into the inner cover. The sensor assembly can be orientated in an operating position using an orientation pin located on the sensor assembly.

### TECHNICAL FIELD

Embodiments are generally related to sensors and, more particularly, to sensors for measuring gas parameters, such as gas constituent concentration, temperature and pressure. Embodiments are additionally related to covers used in such sensors for protecting sensing elements from high velocity gases. Embodiments are also related to gas sensor assemblies for measuring exhaust gases being discharged through an exhaust pipe of an internal combustion engine. Additionally, embodiments are related to methods for assembling such sensors to exhaust pipes and other types of gas carriers.

### BACKGROUND

Typical sensors for measuring a specific gas parameter, like for example gas constituent concentration, temperature or pressure, are unreliable and prone to damage in elevated temperature and harsh gas environments.

Exhaust gas sensors are capable of detecting NOₓ and other dangerous constituents of exhaust gases emitted from automotive internal combustion engines but are susceptible to failure caused by high temperature and chemical exposure. Known exhaust gas sensors generally include a sensing element such as a metal oxide semiconductor (MOS), electrochemical element or like element which is configured to detect parameters of exhaust gases introduced into a chamber. In a gas detector, the sensor element is excited by an external supply voltage through a sensor interface module (SIM) to detect parameters of flowing gas.

Gas sensing elements used in exhaust gas detectors are prone to erosion and damage by the exhaust gases and can be ineffective at detecting the concentration of exhaust gas constituents especially in exhaust gases emitted by diesel engines which typically contain a significant amount of soot particulates. Alternatively or additionally, exhaust sensors can be temperature sensors like thermistor, thermocouple or other sensors other than gas detectors.

Having regard to the foregoing, there is a need for robust sensors which are capable of operating effectively in elevated temperature and harsh gas environments such as exhaust gas environments.

The embodiments disclosed herein therefore directly address gases the shortcomings of existing sensors for measuring parameters of exhaust and other gases providing a sensor assembly, and sensing element cover for use therewith, which is operable in elevated temperature and harsh gas environments.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect to provide for an improved gas sensor assembly for measuring parameters of exhaust gases or other types of gases in elevated temperature and harsh environments with high flow.

It is another aspect to provide for a cover to protect a sensing element of such a gas sensor assembly.

The aforementioned aspects of the invention and other objectives and advantages can now be achieved as described herein.

According to one aspect, a cover for a sensing element of a sensor has a bottom wall and a sidewall extending upwardly from the bottom wall to the top of the cover. The bottom wall and the sidewall define an interior of the cover and each of the bottom wall and sidewall have at least one opening through which gas can flow. The openings are configured such that, when the cover is attached to the sensor so as to surround the sensing element and gas is flowing into the cover interior via the opening(s), the gas flow in the cover interior concentrates in the vicinity of the sensing element. The sensing element can be for example a sensing element of an exhaust sensor assembly for measuring parameters such as gas constituent concentration, pressure or temperature of an exhaust gas.

By configuring the cover openings so that, in addition to traveling at reduced gas flow velocity, the gas flowing into the cover interior concentrates in the vicinity of the sensing element, the sensing element can more effectively detect the gas parameter under investigation, such as for example the gas constituents, temperature or pressure.

Preferably, one or more of the sidewall openings is configured as a gas inlet and one or more bottom wall openings is configured as a gas outlet so that gas flow entering the gas inlet is drawn in a downward motion in the cover interior and out of the gas outlet.

The sidewall opening(s) can be configured to promote rotary or swirling movement of the gas flowing in the cover interior such that at least some particulates, such as soot, water vapor or high mass density particulars, contained in the gas are directed away from the gas sensing element further increasing the measurement effectiveness of the sensor assembly. Advantageously, diverting soot or other particulates away from the sensing element reduces or substantially eliminates deposition of the particulates on the sensing element so that the sensing element is less prone to damage from exposure to the particulates and, in turn, the sensing element life time is increased.

The gas inlet can comprise a slot disposed in an upper portion of the sidewall at the upstream side thereof, the slot extending substantially parallel to the longitudinal axis of the sensor assembly. The sidewall can be at least partially cylindrical and/or frusto conical in form and extends upwardly from the bottom wall to a mouth at the top of the cover.

In another preferred embodiment, the bottom wall and the sidewall can define an inner cover and an outer cover can surround the inner cover to define a double cover structure. The outer cover can have a sidewall having at least one opening through which gas can pass. The inner and outer cover sidewalls can be configured as a pair of substantially concentric cylinders. One ore more sidewall openings of the inner cover can be disposed in closer proximity to the bottom wall of the inner cover than the one or more openings of the outer cover. Furthermore, opening(s) of the outer cover sidewall can be distributed generally only on an upstream side of the cover so that gas flowing into the outer cover through the outer cover sidewall opening(s) is prevented from escaping through a downstream side of the outer cover and generally travels in a downward motion in the outer cover into the inner cover via the inner cover sidewall openings.

According to another aspect, a sensor system comprises a pipe, such as an exhaust pipe, through which gas can flow, and a sensor assembly for measuring a parameter of the flowing gas. The sensor assembly has a housing, a sensing element mounted in the housing for sensing a parameter of the gas, and a cover attached to the housing so as to surround the sensor element. The cover has a bottom wall and a sidewall extending upwardly from the bottom wall to the top of the cover. The bottom wall and the sidewall define an interior of the cover and each of the bottom wall and sidewalls has at least one opening through which gas can flow. The sensor assembly is fixable in a wall of the pipe in an operating position in which the gas flowing in the pipe enters the cover interior via the sidewall opening(s). The bottom and sidewall openings are configured such that the gas flowing in the cover interior travels in a downward motion and concentrates in the vicinity of the sensing element.

The housing can be configured to be fixable to a mount located on the pipe wall. The sensor assembly can have an orientation pin configured to be engageable with a corresponding slot or notch formed on the pipe mount so as to facilitate orientation of the sensor assembly into the operating position.

The sensor assembly includes a rear tube fixed to the housing for mounting a cable to the sensor assembly. The rear tube, housing and/or cover can be formed from a nickel alloy or other high temperature resistant material so that the sensor assembly is capable of withstanding corrosive and high temperature gases present in the exhaust flow. Furthermore, the cover and/or rear tube can be fixed to the housing by one or more laser welded joints. Also, a ceramic potting material can be used to surround or package the sensing element in the housing.

Advantageously, the resulting sensor assembly is capable of withstanding temperatures ranging from about −40° C. to about +850° C. to +1000° C., high vibration and mechanical shock and has a long operating life time. Furthermore, the packaging enables low response times of the sensor element e.g. (<0.5 sec).

The opening(s) can be configured to promote rotary or swirling movement of the gas flowing in the cover interior such that at least some particulates contained in the gas are directed away from the gas sensing element.

The sensor assembly can be fixed in the operating position in which the longitudinal axis of the sidewall is substantially perpendicular to the path of the oncoming gas flow in the pipe and such that the sidewall opening(s) are on the upstream side of the cover and located off set from a central transverse axis of the cover which is parallel with the oncoming gas flow path.

The bottom wall and said sidewall define an outer cover and further comprise an inner cover generally surrounding. The outer cover and having a sidewall having at least one opening through which gas can pass, the inner and outer covers defining a double cover structure. The one or more sidewall openings of the inner cover is disposed in closer proximity to the bottom wall of the inner cover than the sidewall opening(s) of the outer cover such that the gas flow entering the cover travels generally in a downward motion and enters the inner cover via the inner cover sidewall openings. The outer cover sidewall can be configured to have the sidewall openings generally on one side to form a gas inlet and to have a blank opposite side. The sensor assembly can be fixed in the operating position in which the gas inlet is on the cover upstream side and the blocked side forms the cover downstream side thereby preventing gas flowing into the outer cover gas inlet from escaping through the downstream side of the outer cover sidewall.

According to another aspect, there is a method of assembling a sensor assembly to a pipe, the sensor assembly having a housing, a sensing element mounted in the housing for sensing a parameter of gas flowing in the pipe, and a cover attached to the housing so as to surround the sensor element, the cover comprising a bottom wall and a sidewall extending upwardly from the bottom wall to the top of the cover, the bottom wall and the sidewall defining an interior of the cover and each having at least one opening through which gas can flow. The method comprises providing a pipe through which exhaust gas can flow, inserting the cover side of the sensor assembly into a sidewall of the pipe, orientating the sensor assembly in an operating position in which the gas flowing in the pipe enters the cover interior via the sidewall opening(s), travels in a downward motion and concentrates in the vicinity of the sensing element, and fixing the sensor assembly to the pipe in the operating position.

The method step of orientating the sensor assembly in the operating position can further comprise orientating the sensor assembly so that the longitudinal axis of the cover is substantially perpendicular to the gas flow and so that the sidewall opening(s) form a gas inlet on the upstream side of the cover and located off set from a central transverse axis of the cover which is parallel with the path of the oncoming gas flow in the pipe thereby to promote rotary or swirling movement of the gas flowing in the cover interior.

The method can further comprise the steps of forming an exhaust mount on the sidewall, the exhaust mount having a bore aligned with the aperture, and forming an orientation pin on the housing and a corresponding notch or slot on the exhaust mount, wherein the step of inserting the cover side of the sensor assembly into the pipe sidewall comprises inserting the cover side of the sensor assembly through the exhaust mount bore and the aperture into the pipe, wherein the step of orientating the sensor assembly comprises engaging the housing pin with the slot or notch of the exhaust mount, and wherein the step of fixing the sensor assembly to the pipe in the operating position comprises fixing the housing to the exhaust mount.

According to yet another aspect, a method for protecting a sensing element of a sensor for measuring a gas parameter comprises the steps of forming a cover comprising a bottom wall and a sidewall extending upwardly from the bottom wall to the top of the cover, the bottom wall and sidewall defining an interior of the cover, configuring at least one opening in each of the bottom wall and sidewall and attaching the cover to the sensor so as to surround the sensing element so that gas can flow into the cover interior via the opening(s) and concentrate in the vicinity of the sensing element.

The method can further comprise configuring the sidewall opening(s) as a gas inlet and the bottom wall opening(s) as a gas outlet such that gas flow entering the gas inlet is drawn in a downward motion in the cover interior and out of the gas outlet. The method can further comprise configuring the openings to promote rotary or swirling movement of the gas flowing in the cover interior such that at least some particulates contained in the gas are directed away from the gas sensing element. Configuring the openings to promote rotary movement can include forming a slot in an upper portion of the sidewall at the upstream side thereof, the slot extending substantially parallel to the longitudinal axis of the sensor assembly.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a longitudinal cross-sectional view of a gas sensor assembly disposed in a wall of an exhaust pipe according to one embodiment;

FIG. 2 illustrates a perspective view of the sensing element cover of the gas assembly of FIG. 1;

FIG. 3 illustrates a cross-sectional side view of the cover of FIG. 2;

FIG. 4 illustrates an enlarged partial view of FIG. 1 showing in more detail the sensing element cover attached to the gas assembly housing;

FIG. 5 illustrates a cross-sectional view taken along line A-A of FIG. 4;

FIGS. 6 and 7 respectively illustrate cross-sectional and perspective views of a gas sensor assembly mounted in the wall of an exhaust pipe according to another embodiment;

FIG. 8 illustrates a perspective view of a double structure cover used in the gas assembly shown in FIG. 6;

FIG. 9 illustrates a partial enlarged view of the gas sensor assembly of FIG. 6 inserted into the wall of an exhaust pipe;

FIGS. 10 & 11 respectively illustrate cross-sectional views taken along lines A-A and B-B shown in FIG. 9; and

FIG. 12 illustrates a perspective view of the gas sensor assembly of FIG. 1 partially inserted into the sidewall mount of the exhaust pipe.

### DETAILED DESCRIPTION OF THE INVENTION

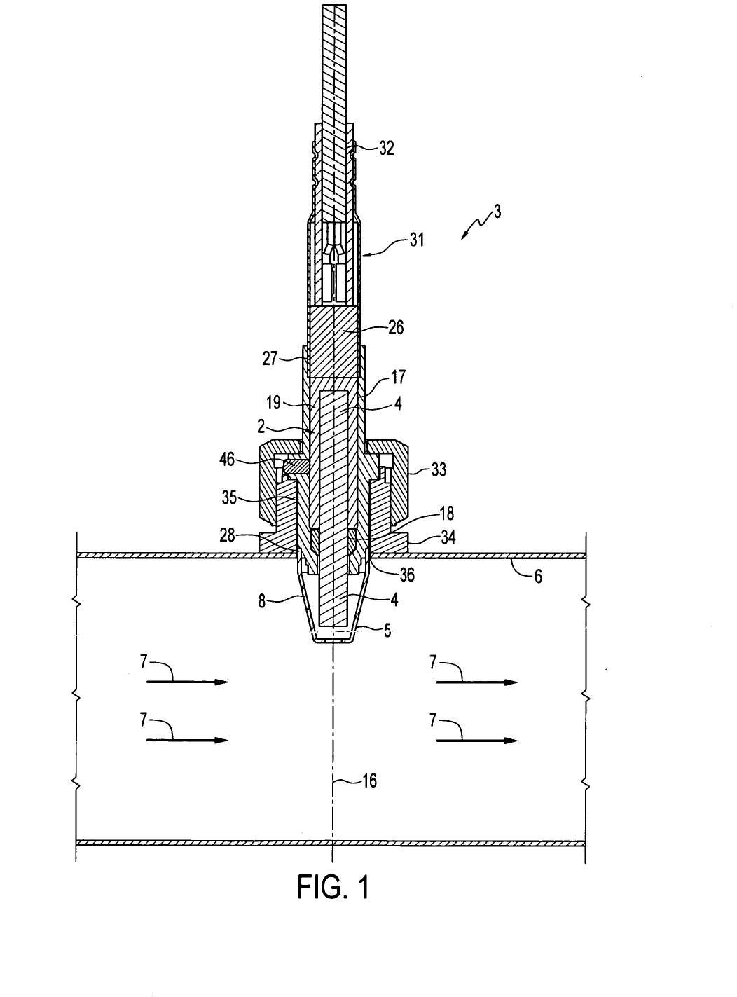

Referring to FIG. 1 of the accompanying drawings, which illustrates a longitudinal cross-sectional view of a gas sensor assembly disposed in a wall of an exhaust pipe according to one embodiment, the gas sensor assembly 3 includes a housing 2, a sensing element 4 mounted in the housing and a cover 5 which is fixed to a front end of the housing such that the sensing element is surrounded by the cover. In the illustrative embodiment shown in FIG. 1, the gas sensor assembly is configured to be disposed in a wall of an exhaust pipe 6 of an internal combustion engine, such as a diesel engine, for sensing constituents of exhaust gases discharged from the engine and flowing through the exhaust pipe 6 in the direction indicated by arrows 7. As will be explained in more detail below, the cover 5 serves both to protect the sensing element 4 from damage and erosion and enables the sensing element to measure the gas constituents more effectively.

In the illustrative embodiment shown in FIG. 1, the sensing element 4 is a gas sensing element for sensing concentration of an exhaust gas constituent. A typical exhaust gas constituent to be sensed by the gas sensor assembly 1 can be NOₓ, NO, NO₂, HC, O₂, NH₃, CO, SOₓ, SO₂, CO₂ or other gases. However, the sensing element could alternatively be configured to sense another gas parameter such as temperature, pressure or particulate levels, like for example soot levels. In alternative embodiments, the gas sensor assembly can be implemented in gas flow systems other than exhaust systems to measure the same or other types of gas constituents or other gas parameters and is not limited to being implemented in internal combustion exhaust systems. such as for example, shown in FIG. 1.

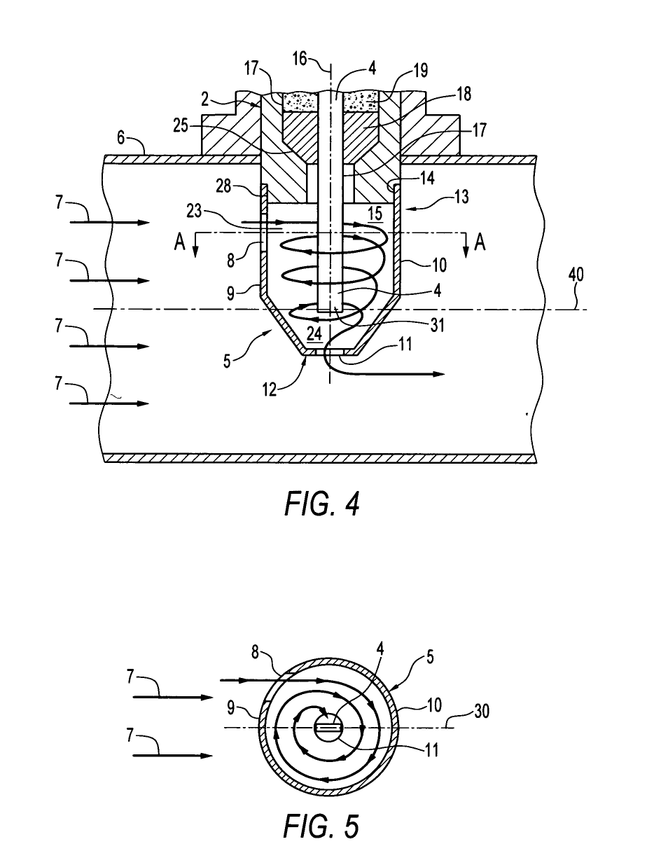

Referring now to FIG. 4, which illustrates an enlarged partial view of FIG. 1 showing the cover side of the gas assembly in more detail, sensing element 4 is mounted axially within the housing 2 and the cover 5 is attached at its mouth 14 to the front of the housing such that a front portion of the sensing element protrudes axially into the cover interior 15 and is spaced from the cover.

Referring additionally to FIG. 1, the housing 2 is generally cylindrical in shape and has a longitudinal bore 17. A ceramic ring 18 is seated in the front end of the bore 17 on a frusto conical shaped inner shoulder 25 and has a hole extending along the bore longitudinal axis 16 through which the sensing element 4 extends on into the cover interior 15 via a front neck of the bore. Another ceramic ring or sleeve 26 is arranged spaced from ceramic ring 18 in a front end of a rear tube 31 which is fixed in the rear end of the housing bore 17 by means of a laser welded annular joint 27 between the rear tube exterior and bore interior walls. The ceramic sleeve 26 also has a hole extending along the longitudinal axis 16 through which the rear end of the sensing element 4 extends and electrically connects to cable 32 housed in the rear tube. Cable 32 is connectable to a control system (not shown) for controlling and analyzing the sensing element output as is known in the art.

The ceramic ring 18 together with the sensing element 4 are packaged in place within the bore 17 using a ceramic potting material 19 which is located in the bore 17 between the ceramic rings 18, 26 and which surrounds the sensing element. The ceramic potting material 19 has a low heat transfer and can withstand high thermal cycling. The cover 5 is fixed to the front end of the housing 2 by means of an annular laser welded joint 28 between the interior of the cover mouth 14 and the housing exterior wall.

The housing 2, sensing element 4 and cover 5 are formed from metal and, preferably, a high nickel alloy, such as SS316 (for below 800° C.) or Inconel (above 800 to 1000° C.) depending upon application temperature, or_other high temperature resistant material, so that the gas sensor is capable of withstanding corrosive and high temperature gases present in the exhaust flow.

Advantageously, the resulting gas sensor assembly 3 is capable of withstanding temperatures ranging from about −40° C. to about +850° C. to +1000° C., high vibration and mechanical shock and has a long operating life time. Furthermore, the packaging enables low response times of the sensor element e.g. (<0.5 sec).

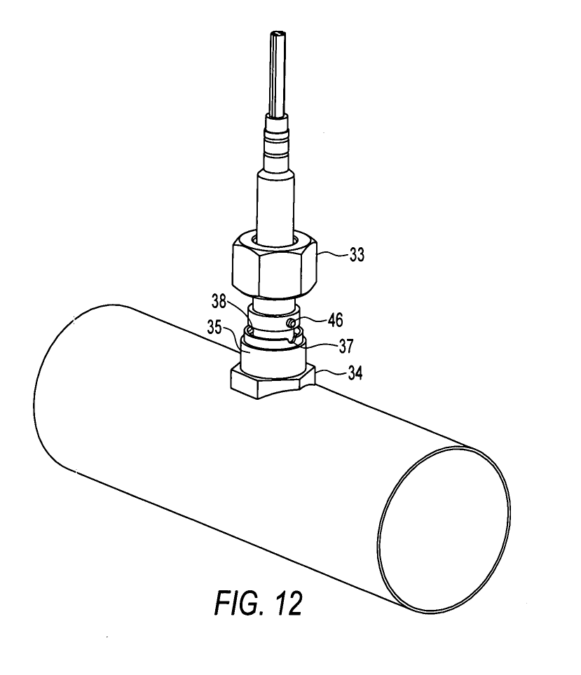

As best shown in FIG. 1 in conjunction with FIG. 12 which illustrates a perspective view of the gas assembly of FIG. 1 partially inserted into a mount of the exhaust pipe, the front end or cover side of the gas sensor assembly 3 is inserted through a sidewall aperture 36 of the exhaust pipe 6. An exhaust mount 34 has a longitudinal bore 35 and has a bottom fixed to the pipe sidewall exterior with the bore longitudinal axis substantially aligned with the exhaust pipe sidewall aperture central axis so that the front end of the assembly 3 can extend through the exhaust mount bore 35 and pipe sidewall aperture 36 into the pipe in an operating position. Assembly 3 is secured to the pipe sidewall in its operating position by means of a nut 33 which is mounted on the exterior of the housing 2 and which is threadably engageable with the exterior of the exhaust mount 34.

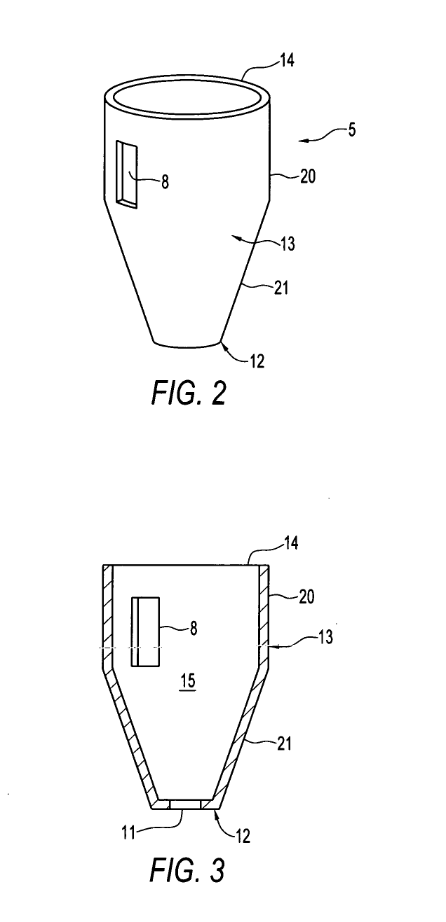

Turning now in more detail to the cover 5, FIGS. 2 & 3 respectively illustrate a perspective and cross-sectional views of the sensing element cover used in the gas assembly of FIG. 1. The sensing element cover 5 has a bottom wall 12 and a sidewall 13 extending upwardly from the bottom wall to a mouth 14 at the top of the cover to thereby define an interior 15 of the cover (see FIG. 3). Both the sidewall 13 and bottom wall 12 each have an opening 8, 11 formed therein through which exhaust gas can flow. The openings 8, 11 are configured such that, when the cover is attached to the gas sensor assembly housing 2 so as to surround the sensing element 4, gas flowing into the cover interior 15 via opening 8 concentrates in the vicinity of the sensing element 4 disposed in the cover interior so that the gas sensor assembly is both more robust and capable of detecting the gas constituents more effectively.

In the illustrative embodiment of the cover shown in FIGS. 2 & 3, the cover sidewall 13 diverges upwardly from an annular bottom wall 12 to from a frusto conical shaped (truncated cone) lower sidewall portion 21 and continues to extend upwardly substantially vertically to the mouth 14 at the top of the cover to form a cylindrical upper portion 20. In alternative embodiments of the gas sensor, assembly 3, the sidewall 13 and bottom wall 12 may be of other shapes which can generally surround the sensing element. Sidewall opening 8 is preferably disposed in the upper sidewall portion 20 closer to the top of the cover than to the bottom wall 12 and extends substantially vertically forming an elongated opening or slot 8 (see FIG. 2) whilst the bottom wall opening 11 is an annular opening disposed centrally of the bottom wall.

As shown in FIG. 4, the cover side of gas sensor assembly 3 is disposed in the wall of the exhaust pipe 6 so that the gas sensor assembly longitudinal axis 16 is substantially perpendicular to the exhaust pipe longitudinal axis and so also substantially perpendicular to the path of gas flow through the pipe indicated by arrows 7. As best shown in FIG. 12, a transversely extending orientation pin 46 is mounted in one side of the sensor housing 2 for orientating the gas assembly 3 in this operating position. The orientation pin 46 is configured to be engageable with a corresponding slot or notch 37 formed in a top annular wall 38 of the exhaust mount 34 so that the gas sensor assembly 3 is orientated in the exhaust pipe 6 in its proper operating position in which the outer sidewall slot 8 is on the upstream side 9 of the cover 5, that is, the side of the cover directly exposed to the incoming gas flow in the pipe (see FIG. 4). As a result, the outer sidewall slot 8 functions as a gas inlet through which the exhaust gas flows into the cover interior 15 and the bottom wall opening 11 functions as a gas outlet, as indicated in FIG. 4. The pin is advantageous in that it enables the sensor assembly to be oriented relative to the oncoming gas flow direction automatically during assembly in the exhaust pipe.

As indicated by the arrows representing the gas flow through the sidewall opening 8 into the cover interior 16, shown generally at 23 in FIG.4, configuring the sidewall opening 8 as a gas inlet and the bottom wall opening 11 as a gas outlet causes gas flow to be drawn in a downward motion from the top to the bottom of the cover interior.

As best shown in FIG. 4 and additionally FIG. 5, which illustrates a cross-sectional view taken along line A-A of FIG. 4, the gas sensor assembly is also arranged so that the sidewall slot 8 is off set from a central transverse axis 30 of the cover which is parallel to the oncoming gas flow path 7. The blank side of the cover, that is, the side without openings, is orientated as the downstream side 10 of the cover, that is, the side which is not directly exposed to the incoming gas flow.

Orientating the gas sensor assembly 3 in the aforementioned manner promotes or induces rotary or swirling downward motion of the gas flow entering the cover interior 15 through the slot 8 which, in turn, causes the incoming gas flow to be effected by centrifugal forces so that the gas flows in a helical downward direction to the cover bottom wall 12 and out of the cover through the bottom wall opening 11, as indicated by arrows shown generally at 23 & 24. The frusto conical lower section 21 of the cover further promotes rotary motion. In this way, the generated centrifugal forces exerted on gas particulates contained in the gas flow cause the gas particulates, which are heavier than the gas constituents, to travel outwardly towards the sidewall 13 so that they are diverted away from the axially extending sensing element 4, and cause the gas constituents to flow to the central region of the cover interior 15 in the vicinity of the sensing element. Thus, the gas constituents are separated from the particulates and concentrated in the vicinity of the sensing element 4. In the illustrative embodiment, the gas particulates are soot particles. However, in alternative embodiments, the particulates may be carbon, water vapor or high density elements.

By configuring the cover openings 8, 11 so that the sensing element can detect gas flow which is both concentrated and traveling at a reduced gas flow velocity, the sensing element is both protected from high velocity gases and is capable of detecting the gas constituents more effectively.

Additionally, adapting and arranging the openings 8,11 to promote circulatory or swirling movement of the gas flowing into the cover such that particulates contained in the exhaust gas are diverted away from the sensing element allows the gas constituents to separate from the particulates and to flow alone in the vicinity of the sensing element further increasing the measurement effectiveness of the gas sensor assembly. Furthermore, diverting the soot or other particulates away from the sensing element 4 advantageously reduces or substantially eliminates deposition of the particulates on the sensing element so that the sensing element is less prone to damage from exposure to the particulates and, in turn, the sensing element life time is increased.

Dimensions of the cover 5 including the sidewall and bottom wall openings 8, 11 can vary. For example, for a cover 5 in which the diameters of the mouth 14 and bottom wall 12 are about 13.5 mm and 8 mm and the cover length is about 20 mm, the sidewall opening 8 can have a length and width of about 5 mm and 1.9 mm, respectively, and can be located such that the top of the opening is about 6.6 mm from the cover mouth. The bottom wall opening 11 can be about 3.5 mm in diameter. Whilst in the illustrative embodiment of the gas assembly shown in FIGS. 1-5, the sidewall opening is a rectangular slot, other shape openings can be employed to serve as a gas inlet and provide the necessary rotary movement of the gas flow in the cover interior. Furthermore, whilst a single slot 8 is used, more than one sidewall opening could be employed and can be distributed in a variety of ways so that the net gas flow enters the cover on the downstream side of the cover at a sidewall location off set from the transverse axis 30 thereby causing rotary movement of the gas. Also, the shape of the bottom wall opening(s) need not be limited to a circular opening.

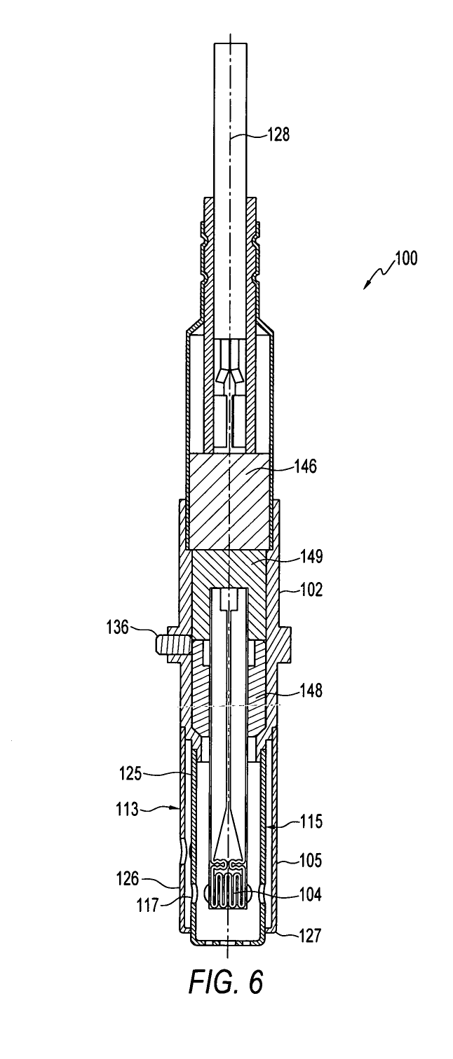

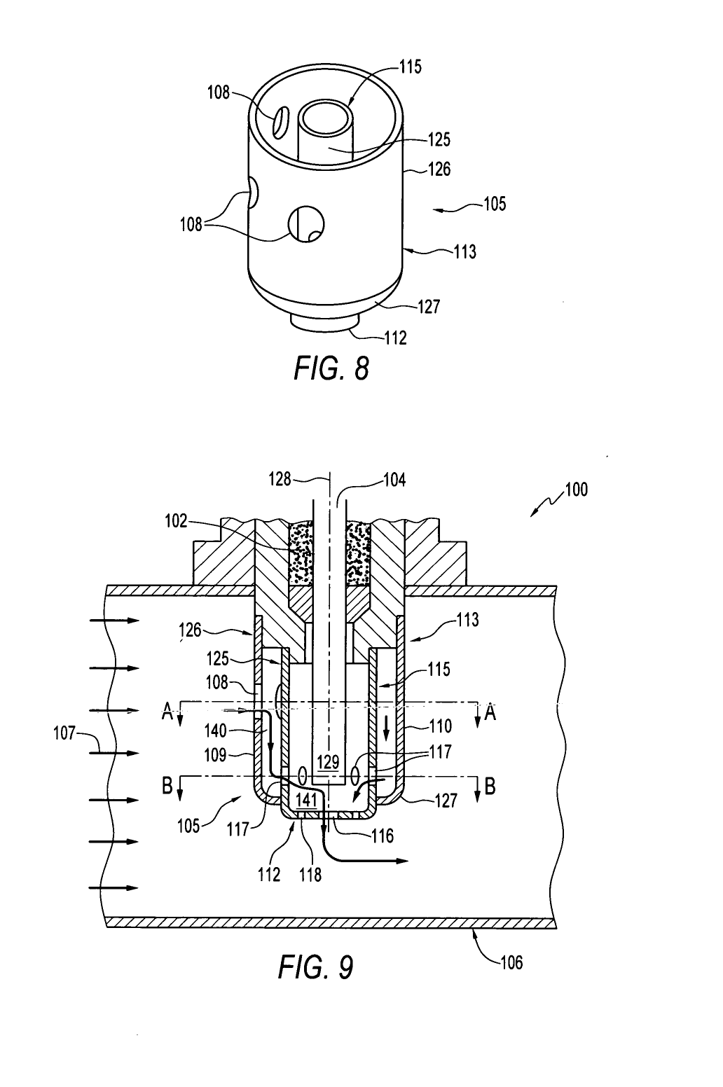

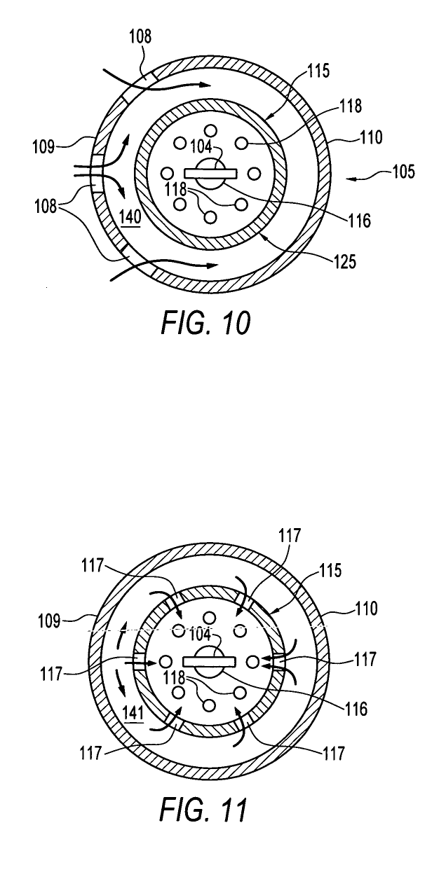

Referring now to FIGS. 6 & 7, there is respectively illustrated a gas sensor assembly 100 in cross sectional view and perspective view according to another embodiment in which the sensing element cover 105 has an inner cover 115 and an outer cover 113 mounted substantially concentric with the inner cover to form a double structure cover. With the exception of the double structure cover 105, the gas sensor assembly 100 shown in FIG. 6 is similar in structure to the gas sensor assembly 3 of the first embodiment shown in FIG. 1. Thus, gas sensor assembly 100 has a housing 2 including orientation pin 136, lower and upper ceramic insulators 146,148 laser welded to opposing ends of the housing and separated by potting material 149, and a sensing element 104 protruding from the housing 2 into the cover. FIGS. 8 & 9 respectively illustrate a perspective view (not to scale) of the double structure cover used in the gas sensor assembly of FIG. 6 and a partial cross-sectional view of the cover side of the gas sensor assembly mounted to an exhaust pipe wall in its operating position. FIGS. 10 & 11 illustrate cross-sectional views taken along lines A-A and B-B shown in FIG. 9.

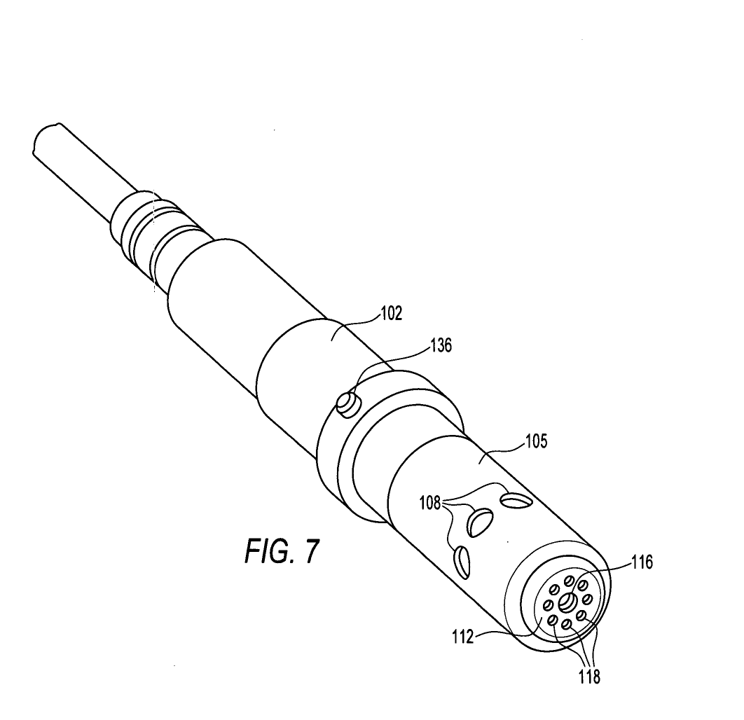

Referring now to the cover 105 in more detail, the inner cover 115 has a cylindrical sidewall 125 extending upwardly from a circular bottom wall 112. A cylindrical sidewall 126 of the outer cover 113 surrounds the inner cover sidewall 125 and has a bottom end 127 terminating at a bottom region of the outer surface of the inner cover sidewall 125 (see FIGS. 6 & 8). A plurality of annular openings 117, in this particular embodiment 8 openings, through which gas can pass are distributed at equidistant intervals about the circumference of the inner cover sidewall 125 towards the bottom wall 112 and are aligned in the same virtual plane perpendicular to the longitudinal axis 128 of the assembly 100 (see FIGS. 9 & 10). The sensing element tip 129 is also located in the vicinity of this virtual plane. As best shown in FIG. 7, a circular opening 116 is also disposed centrally in the inner cover bottom wall 112 together with a plurality of smaller circular openings 118, in this particular embodiment 8 openings, distributed at equidistant intervals spaced around the central opening 116 in the outer annular region of the bottom wall. The outer bottom openings 112 are made smaller to reduce visibility and avoid entry of fingers etc. during assembly of the cover to the housing.

As best shown in FIG. 7, in conjunction with FIG. 8, a plurality of circular openings 108, in this particular embodiment 3 openings, through which gas can pass are located only on one side of the outer cover sidewall 126 and distributed also about the circumference at equidistant locations in the same virtual plane perpendicular to the longitudinal axis 128. The inner cover sidewall openings 117 are surrounded by the outer cover 113 and located in closer proximity to the inner cover bottom wall 112 than are the outer cover sidewall openings 108.

For an outer cover 113 having a height and diameter of 18 mm and 8.6 mm, respectively, the outer cover sidewall openings can each have a diameter of about 5 mm located about 10.4 mm in height from the bottom of the outer cover sidewall 126. The central bottom wall opening can be about 9.6 mm in diameter. The sidewall openings 108 are arranged such that their central axes are at 45 degrees relative to one another. The inner cover has a height and diameter of about 16.5 mm and 8.6 diameters, respectively, and the inner cover sidewall openings 117 have diameters of 3 mm, located 5.9 mm from the bottom wall. The inner cover bottom wall central opening 116 is about 2.5 mm in diameter and the outer openings 118 surrounding the central opening are 1.2 mm in diameter with their centers located at about 1.9 mm from the perimeter of the bottom wall 112.

As indicated in FIG. 9, the gas sensor assembly 100 is disposed in the wall of an exhaust pine 106 in the same manner as the gas sensor assembly 3 of the embodiment shown in FIG. 1 is disposed in the wall of exhaust pipe 6, that is, so that the gas sensor assembly longitudinal axis 128 is substantially perpendicular to the exhaust pipe longitudinal axis and so also substantially perpendicular to the path of oncoming gas flow through the pipe indicated by arrows 107. The sensor housing is orientated by means of the pin 136 being engaged in the slot of the exhaust mount (not shown) so that the sensor assembly is fitted to the exhaust pipe in its operating position in which the outer sidewall openings 108 are arranged on the upstream side 109 of the cover and so that the blank side of the outer sidewall (the side without openings) is arranged as the downstream side 110 of the cover (see FIG. 9). Thus, the outer sidewall openings 108 function as a gas inlet through which the exhaust gas flows into the cover interior and the bottom wall openings 116,118 of the inner cover function as a gas outlet through which gas flows out of the cover as indicated in FIG. 9.

As indicated by the arrows representing the gas flow through the inner and outer sidewall openings, shown generally at 140, 141 in FIGS. 9-11, the blank side of the outer sidewall 126 prevents the gas flow in the outer cover 113 from escaping from the outer cover downstream side 110 and serves to confine the gas between the inner and outer cover sidewalls so that a substantial amount of the gas flow entering the outer cover travels in a downward motion between the inner and outer cover sidewalls 125,126 towards the inner cover sidewall openings 117 ( see FIGS. 9-11). Thereafter, the gas flow is guided into the inner cover through the inner cover sidewall openings 117 and concentrates to the sensing element tip 129, before passing out of the inner cover through the inner cover bottom wall openings 116,118.

Advantageously, the sidewalls and sidewall openings of the inner and outer covers are configured to appropriately reduce the velocity of the pipe gas flow whilst concentrating the gas flow introduced into the cover interior towards the gas sensing element disposed therein.

In alternative embodiments of the gas sensor assembly, the outer cover sidewall openings can be disposed at non-equidistant locations and/or in different planes as well as be distributed about both the down and upstream sides of the cover if necessary whist still obtaining some of the benefits of gas flow concentration towards the sensing element. Furthermore, the openings can be of shapes other than circular.

The description as set forth is not intended to be exhaustive or to limit the scope of the invention. For example, those skilled in the art would understand that the apparatus of the illustrative embodiments disclosed herein may be employed for measuring the position of substances, materials or media rather than a piston or other member. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The embodiments of the invention in which an exclusive property or right is claimed are defined as follows. Having thus described the invention what is claimed is:

1. A cover for a sensing element of a sensor for measuring a parameter of a gas, said cover comprising a bottom wall and a sidewall extending upwardly from said bottom wall to the top of said cover, said bottom wall and said sidewall defining an interior of said cover and each of said bottom wall and said sidewall having at least one opening through which gas can flow,
wherein said openings are configured such that, when said cover is attached to said sensor so as to surround said sensing element and gas is flowing into said cover interior via said opening(s), said gas flow in said cover interior concentrates in the vicinity of said sensing element.

2. The cover of claim 2, where said at least one sidewall opening is configured as a gas inlet and wherein said at least one bottom wall opening is configured as a gas outlet, said gas flow entering said gas inlet being drawn in a downward motion in said cover interior and out of said gas outlet.

3. The cover of claim 2, wherein said at least one sidewall opening is configured to promote rotary or swirling movement of said gas flowing in said cover interior such that at least some particulates contained in said gas are directed away from said gas sensing element.

4. The cover of claim 3, wherein said gas inlet comprises a slot disposed in an upper portion of said sidewall at the upstream side thereof, said slot extending substantially parallel to the longitudinal axis of said sensor assembly.

5. The cover of claim 3, wherein said sidewall is at least partially cylindrical and/or frusto conical in form and extends upwardly from said bottom wall to a mouth at the top of said cover.

6. The cover of claim 2, wherein said bottom wall and said sidewall define an inner cover and further comprising an outer cover surrounding said inner cover to define a double cover structure, said outer cover having a sidewall having at least one opening through which gas can pass.

7. The cover of claim 6, wherein said at least one sidewall opening of said inner cover is disposed in closer proximity to the bottom wall of said inner cover than said at least one sidewall opening of said outer cover.

8. The cover of claim 7, wherein said openings of said outer cover sidewall are distributed generally only on an upstream side of said cover so that gas flowing into said outer cover through said outer cover sidewall openings is prevented from escaping through a downstream side of said outer cover and generally travels in a downward motion in said outer cover towards said inner cover sidewall openings.

9. The cover of claim 6, wherein said inner and outer cover sidewalls comprise a pair of substantially concentric cylinders.

10. A sensor system for sensing a parameter of a gas, said sensor assembly comprising
a pipe through which gas can flow,
a sensor assembly having a housing, a sensing element mounted in said housing for sensing a parameter of said gas, and a cover attached to said housing so as to surround said sensor element, said cover comprising a bottom wall and a sidewall extending upwardly from said bottom wall to the top of said cover, said bottom wall and said sidewall defining an interior of said cover and each of said bottom wall and said sidewall having at least one opening through which gas can flow,
wherein said sensor assembly is fixable in a wall of said pipe in an operating position in which said gas flowing in said pipe enters said cover interior via said sidewall opening(s), said bottom wall and sidewall openings being configured such that said gas flowing in said cover interior travels in a downward motion and concentrates in the vicinity of said sensing element.

11. The system of claim 10, wherein said pipe sidewall has an aperture formed therein and a mount located thereon having a bore substantially aligned with the aperture so that the cover side of the sensor assembly is insertable into said pipe via said bore and said aperture, said housing being configured to be fixable to said mount and having an orientation pin configured to be engageable with a corresponding slot or notch formed on said exhaust pipe mount so as to facilitate orientation of said sensor assembly into said operating position.

12. The system of claim 10, wherein said sensor assembly includes a rear tube fixed to said housing for mounting a cable to the sensor assembly, said rear tube, housing and/or cover being formed from a nickel alloy or other high temperature resistant material.

13. The system of claim 12, wherein said cover and/or rear tube is fixed to said housing by at least one laser welded joint.

14. The system of claim 10, wherein said sensing element is surrounded by a ceramic potting material located in said housing.

15. The system of claim 10, wherein said sidewall opening(s) are configured to promote rotary or swirling movement of said gas flowing in said cover interior such that at least some particulates contained in said gas are directed away from said gas sensing element.

16. The system of claim 15, wherein said sensor assembly is fixed in said operating position in which the longitudinal axis of said sidewall is substantially perpendicular to said gas flow and such that said sidewall opening(s) form a gas inlet on the upstream side of said cover, said gas inlet being located off set from a central transverse axis of the cover which is parallel with the oncoming path of said gas flow.

17. The system of claim 10, wherein said bottom wall and said sidewall define an inner cover and further comprising an outer cover generally surrounding said inner cover to define a double cover structure, said outer cover having a sidewall having at least one opening through which gas can pass,
wherein said at least one inner cover sidewall opening is disposed in closer proximity to the bottom wall of said inner cover than said at least one outer cover sidewall opening such that said gas flow entering said outer cover travels generally in a downward motion and enters the inner cover via said inner cover sidewall openings, and
wherein said outer cover sidewall is configured to have said sidewall openings generally on one side and to have a blank opposite side, said sensor assembly being fixable in said operating position in which said outer cover sidewall openings form a gas inlet on the cover upstream side and said blocked side forms the cover downstream side thereby preventing gas flowing into said outer cover gas inlet from escaping through the cover downstream side.

18. A method for assembling a sensor assembly to a pipe, said sensor assembly having a housing, a sensing element mounted in said housing for sensing a parameter of said gas, and a cover attached to said housing so as to surround said sensor element, said cover comprising a bottom wall and a sidewall extending upwardly from said bottom wall to the top of said cover, said bottom wall and said sidewall defining an interior of said cover and each having at least one opening through which gas can flow, said method comprising
providing a pipe through which gas can flow,
inserting the cover side of said sensor assembly into a sidewall of said pipe,
orientating said sensor assembly in an operating position in which said gas flowing in said pipe enters said cover interior via said sidewall opening(s), travels in a downward motion and concentrates in the vicinity of said sensing element, and
fixing said sensor assembly to said pipe in said operating position.

19. The method of claim 18, wherein orientating said sensor assembly in said operating position further comprises orientating said sensor assembly so that the longitudinal axis of said cover is substantially perpendicular to the path of oncoming gas flow in the pipe and so that said sidewall opening(s) form a gas inlet on the upstream side of said cover, said gas inlet being located off set from a central transverse axis of the cover which is parallel with the path of the oncoming gas flow thereby to promote rotary or swirling movement of said gas flowing in said cover interior.

20. The method of claim 19, further comprising
forming an mount on said pipe sidewall, said mount having a bore aligned with an aperture formed in said pipe sidewall,
forming an orientation pin on said housing and a corresponding notch or slot on said mount,
wherein the step of inserting said cover side of said sensor assembly into said pipe sidewall comprises inserting said cover side of said sensor assembly through said mount bore and said aperture into said pipe,
wherein the step of orientating said sensor assembly comprises engaging said housing pin with said slot or notch of said mount, and
wherein the step of fixing said sensor assembly to said pipe in said operating position comprises fixing said housing to said mount.
